(19) United States
(12) Patent Application Publication
(10) Pub. No.: US 2014/0022141 A1
(43) Pub. Date: Jan. 23, 2014

(54) Antenna

(71) Applicant: Unihan Corporation, Taipei (TW)

(72) Inventor: Wei-Chun Tsao, Taipei (TW)

(21) Appl. No.: 13/934,440

(22) Filed: Jul. 3, 2013

(30) Foreign Application Priority Data
Jul. 18, 2012 (TW) 101213866

(51) Int. Cl. H01Q 1/36; H01Q 1/48

(52) U.S. Cl. CPC H01Q 1/36; H01Q 1/48
USPC 343/848

(57) ABSTRACT

An antenna is provided, and includes a coaxial cable. The coaxial cable includes a core wire, an inner insulating layer, a metal layer and an outer insulating layer. The core wire includes a signal feeding portion, a connecting portion and a radiating portion. The connecting portion is electrically connected to the signal feeding portion and the radiating portion. The inner insulating layer encloses the connecting portion. The metal layer partially encloses the inner insulating layer. Parts of the metal layer are separated from the inner insulating layer and include a grounding portion. The outer insulating layer partially encloses the metal layer, and the grounding portion is exposed.

### CROSS-REFERENCES TO RELATED APPLICATIONS

This non-provisional application claims priority under 35 U.S.C. §119(a) on Patent Application No. 101213866 filed in Taiwan, R.O.C. on Jul. 18, 2012, the entire contents of which are hereby incorporated by reference.

### BACKGROUND

1. Technical Field

The disclosure relates to an antenna.

2. Related Art

Antennas are mainly classified as external antennas and internal antennas, in which the external antennas are assembled out of the device and the internal antennas are assembled in the device. Aside from the volume and the aesthetic issues, the external antennas suffer bending or breaking easily upon impact. Consequently, internal antennas have become increasingly popular.

As known in prior arts, mostly a coaxial cable is used as the feeding cable in the conventional antenna assembled on the electric device for receiving and sending wireless signals, and a conductor antenna member, such as a PCB conductor antenna member or an iron-made conductor antenna member is connected to the terminal of the conventional antenna so as to be the radiating portion of the conventional antenna.

However, the dielectric constant of the material which manufactures the conductor antenna member will result in a reduction of the wavelength of the radiation, so that the efficiency of the conventional antenna is reduced to about 50% to 60% of a standard dipole antenna.

Additionally, on assembly, the special limitation must be considered because of the volume of the conductor antenna member and the shape-unchangeable character of the conductor antenna member.

### SUMMARY

In view of this, the present invention proposes an antenna, and the antenna includes a coaxial cable. The coaxial cable includes a core wire, an inner insulating layer, a metal layer and an outer insulating layer. The core wire includes a signal feeding portion, a connecting portion and a radiating portion. The connecting portion is electrically connected to the signal feeding portion and the radiating portion. The inner insulating layer encloses the connecting portion. The metal layer partially encloses the inner insulating layer. Parts of the metal layer are separated from the inner insulating layer and include a grounding portion. The outer insulating layer partially enclosed the metal layer, and the grounding portion is exposed out.

The coaxial cable is directly applied as a conductor antenna member in the present invention so as to reduce the shorten rate of the wavelength caused by the dielectric constant of the material, so that the efficiency of the antenna is improved and becomes comparable with an external dipole antenna. Further, the usage rate of the materials for manufacturing the antenna is reduced so as to reduce the cost of the antenna. Additionally, the fixing member is provided to fix the positions of the radiating portion and the grounding portion via an incompletely enclosing manner so as to keep the radiating direction and protect the radiating portion and the grounding portion.

The detailed features and advantages of the present invention are described below in great detail through the following embodiments, the content of the detailed description is sufficient for those skilled in the art to understand the technical content of the present invention and to implement the present invention there accordingly. Based upon the content of the specification, the claims, and the drawings, those skilled in the art can easily understand the relevant objectives and advantages of the present invention.

### BRIEF DESCRIPTION OF THE DRAWINGS

The present invention will become more fully understood from the detailed description given herein below for illustration only, and thus not limitative of the present invention, wherein:

FIG. 1 is a cross-sectional view of an antenna of a first embodiment of the present invention;

FIG. 2 is a perspective schematic view of an antenna of a second embodiment of the present invention;

FIG. 3 is a perspective schematic view of an antenna of a third embodiment of the present invention; and

FIG. 4 is a perspective schematic view of an antenna of a fourth embodiment of the present invention.

### DETAILED DESCRIPTION

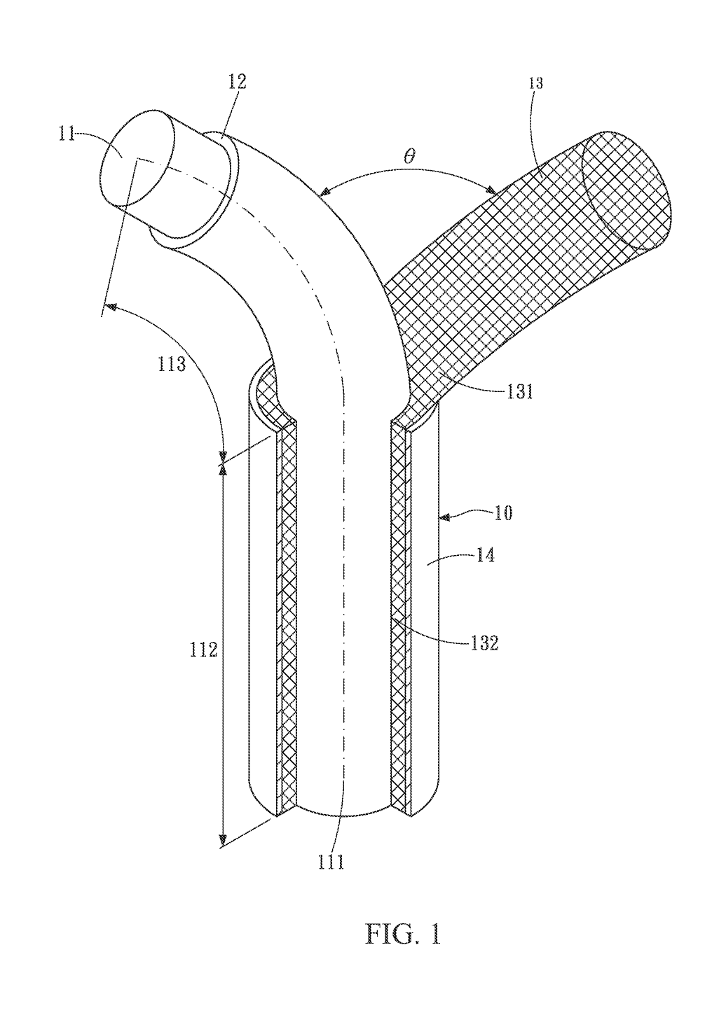

FIG. 1 is a cross-sectional view of an antenna of a first embodiment of the present invention. Please refer to FIG. 1, the antenna is substantially composed of a coaxial cable 10.

The coaxial cable 10 includes a core wire 11, an inner insulating layer 12, a metal layer 13 and an outer insulating layer 14. The inner insulating layer 12, the metal layer 13 and the outer insulating layer 14 are annularly coated on the core wire 11 in order.

The core wire 11 includes a signal feeding portion 111, a connecting portion 112 and a radiating portion 113. The connecting portion 112 is electrically connected to the signal feeding portion 111 and the radiating portion 113. Here, the signal feeding portion 111 and the radiating portion 113 are located at two opposite ends of the connecting portion 112 respectively. That is to say, the core wire 11 can be divided into the signal feeding portion 111, the connecting portion 112 and the radiating portion 113. In some embodiments, the signal feeding portion 111, the connecting portion 112 and the radiating portion 113 are integrally formed as one piece.

The inner insulating layer 12 encloses the connecting portion 112. The metal layer 13 partially encloses the inner insulating layer 12. Parts of the metal layer 13 are separated from the inner insulating layer 12 and include a grounding portion 131.

The outer insulating layer 14 partially encloses the metal layer 13, and the grounding portion 131 is exposed out. That is to say, the grounding portion 131 of the metal layer 13 and the radiating portion 113 of the core wire 11 are exposed from one end of the coaxial cable 10. Additionally, the grounding portion 131 and the radiating portion 113 are separated from each other. The signal feeding portion 111 is disposed at another end of the coaxial cable 10.

Here, the signal feeding portion 111 is exposed out of the coaxial cable 10 so as to electrically couple with an electric device. The signal feeding portion 111 is provided to receive signals sent from the electric device. The received signals are transmitted to the radiating portion 113 through the connecting portion 112 so as to be sent out. Also, radiation signals received by the radiating portion 113 are also transmitted to the signal feeding portion 111 through the connecting portion 112 so as to be further transmitted to the coupled electric device through the signal feeding portion 111.

In some embodiments, a first bending segment is formed between the connecting portion 112 and the radiating portion 113, so that one end of the radiating portion 113 which is opposite to the connecting portion 112 (namely, a first free end of the radiating portion 113 without fastening or connecting with other components), is separated from the grounding portion 131.

In some embodiments, the inner insulating layer 12 enclosed on the radiating portion 113 of the core wire 11 can be optionally retained or removed.

In some embodiments, the metal layer 13 further includes a covering portion 132. The covering portion 132 encloses the inner insulating layer 12 and is electrically connected to the grounding portion 131. Here, the covering portion 132 and the grounding portion 131 are integrally formed as one piece. That is to say, the metal layer 13 can be directly divided into the grounding portion 131 and the covering portion 132. Here, the grounding portion 131 is the segment of the metal layer 13 where the outer insulating layer 14 is removed, and the covering portion 132 is the segment of the metal layer 13 where the outer insulating layer 14 is enclosed on.

In some embodiments, one end of the grounding portion 131 which is opposite to the covering portion 132 is a second free end, and one end of the radiating portion 113 which is opposite to the connecting portion 112 is the first free end. Furthermore, the first free end of the radiating portion 113 and the second free end of the grounding portion 131 are separated from each other. That is to say, the first free end of the radiating portion 113 and the second free end of the grounding portion 131 are extended in different directions.

The first free end of the radiating portion 113 and the second free end of the grounding portion 131 are opposite to a terminal end opposite to the signal feeding portion 111 of the coaxial cable 10. Furthermore, since the antenna of the present invention is mainly composed of the coaxial cable 10, the first free end of the radiating portion 113 and the second free end of the grounding portion 131 do not connect with other components.

In some embodiments, the grounding portion 131 is linear. That is to say, the grounding portion 131 is stranded with the metal layer 13 which is separated from the outer insulating layer 14 and the inner insulating layer 12 so as to be linear.

In some embodiments, in order to cooperate with the electric device, the grounding portion 131 is formed as a sheet shape, a linear shape or other shapes.

In some embodiments, a fixing member 15 is provided to fix the shapes and the positions of the radiating portion 113 and the grounding portion 131. Further, the fixing member 15 leads the first free end of the radiating portion 113 and the second free end of the grounding portion 131 to extend toward different directions.

In some embodiments, the fixing member 15 has a slot 16 provided for assembling with the radiating portion 113 and the grounding portion 131.

In some embodiments, an included angle θ is formed between a first extending direction of the radiating portion 113 and a second extending direction of the grounding portion 131. The included angle θ is larger than zero degree. The included angle θ is smaller than or equal to 180 degrees.

In some embodiments, the included angle θ between the grounding portion 131 and the radiating portion 113 is retained by the fixing member 15.

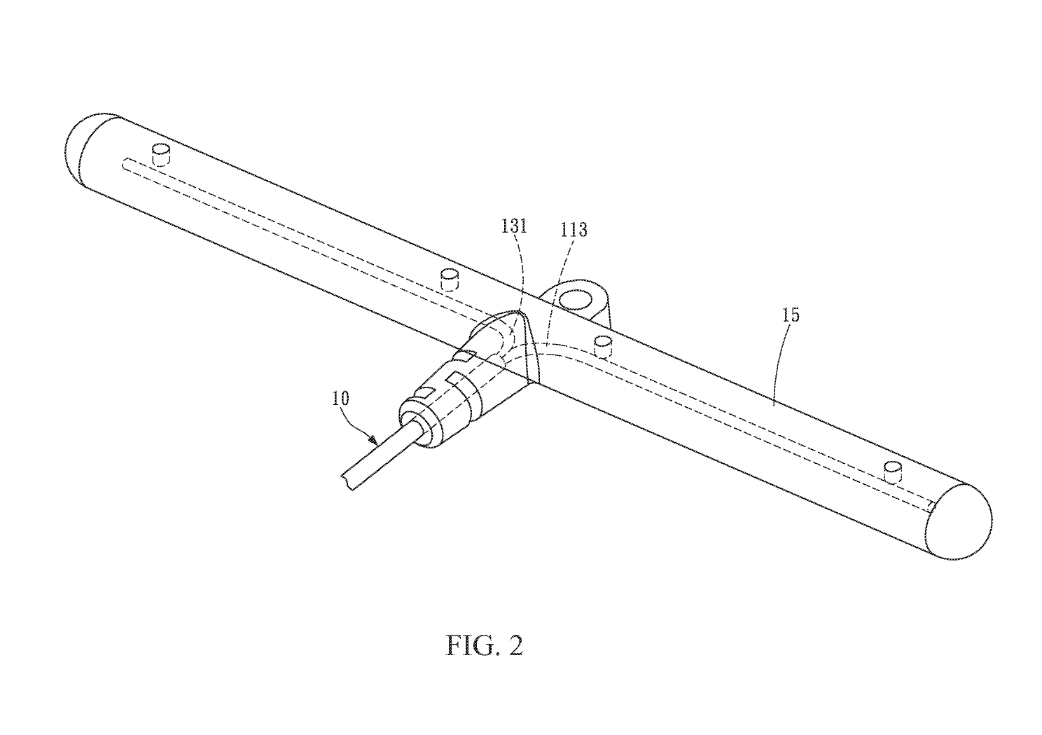

Please refer to FIG. 2, in which the fixing member 15 is T-shaped and encloses the radiating portion 113, the grounding portion 131 and parts of the coaxial cable 10. A transverse portion of the T-shaped fixing member 15 is provided for fixing the radiating portion 113 and the grounding portion 131. And, the crossed portion of the T-shaped fixing member 15 is provided for fixing the first bending segment between the connecting portion 112 and the radiating portion 113 of the core wire 11, and a second bending segment between the covering portion 132 and the grounding portion 131.

In some embodiments, the fixing member 15 protects the radiating portion 113, the grounding portion 131 and the coaxial cable 10. Here, the fixing member 15 prevents bending segments of the core wire 10 and the metal layer 13 from deforming and/or breaking which will result in the antenna cannot receive and send the signals properly because of foreign forces or extrusions.

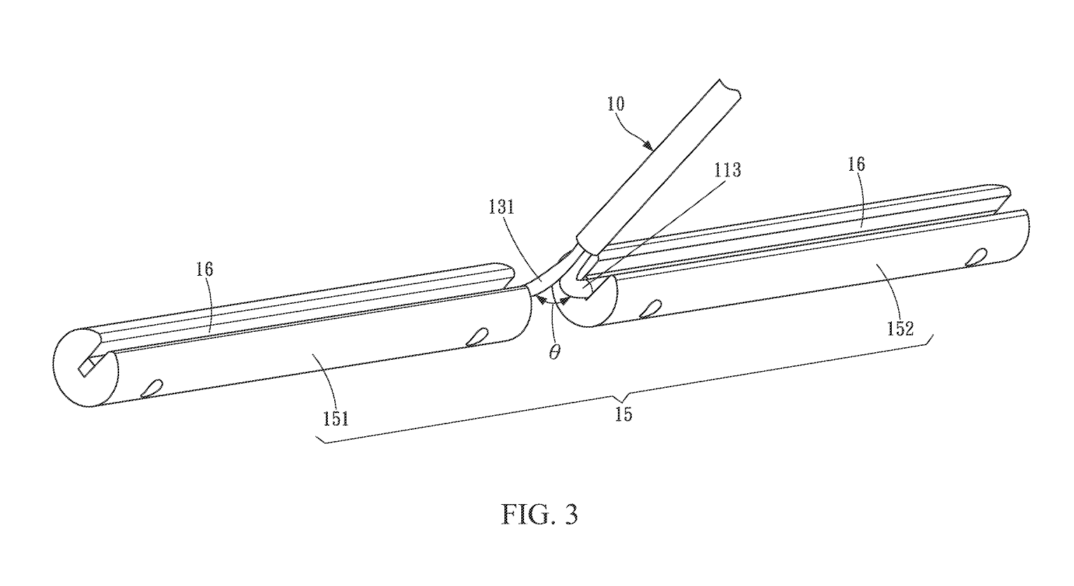

Please refer to FIG. 3, in which the fixing member 15 includes a first fixing portion 151 and a second fixing portion 152. The first fixing portion 151 is provided for fixing the radiating portion 113. The second fixing portion 152 is provided for fixing the grounding portion 131. The radiating portion 113 is fixed in the slot 16 of the first fixing portion 151, and the grounding portion 131 is fixed in the slot 16 of the second fixing portion 152.

Because the first fixing portion 151 and the second fixing portion 152 are movable, the included angle θ between the radiating portion 113 and the grounding portion 131 is adjustable by moving the first fixing portion 151 and the second fixing portion 152.

In some embodiments, the shape of the fixing member 15 can be arbitrary so as to fix the radiating portion 113 and the grounding portion 131.

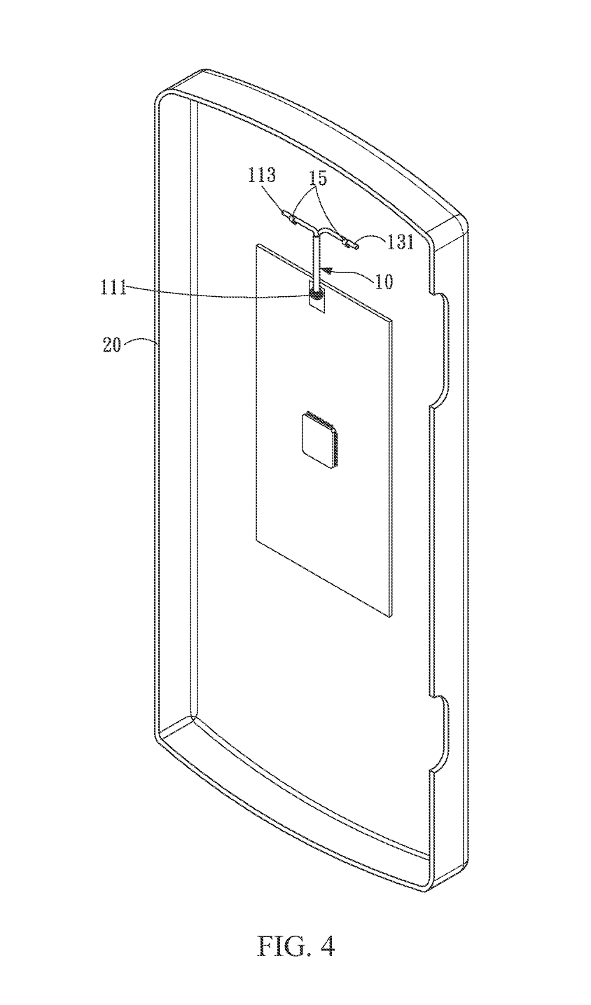

Please refer to FIG. 4, in which the fixing member 15 is annular shaped so as to cooperate with the electric device for fixing the radiating portion 113 and the grounding portion 131. The fixing member 15 is provided for fixing the extending directions of the radiating portion 113 and the grounding portion 131 and keeping the electric device to receive and send the signals properly. The signal feeding portion 111 is fixed on the electric device via soldering or other methods, so that the electric device receives the signals via the signal feeding portion 111.

In some embodiments, the fixing member 15 is made of insulated materials and fixes the radiating portion 113 and the grounding portion 131 in an incompletely enclosing manner so as to reduce the signal shorten rate caused by the dielectric constant of the materials.

In some embodiments, the wavelength corresponding to the operating frequency band of the antenna equals to the summation of the length of the radiating portion 113 and that of the grounding portion 131, so that the electromagnetic frequency sent and received by the antenna can be adjusted (f=c/λ, f is the frequency of the wave, c is the speed of the wave and λ is the wavelength).

For example, when a frequency of 2.4 GHz applicable for wireless network is tended to be applied to the antenna, the total length of the radiating portion 113 and the grounding portion 131 is designated as approximately 3.1 cm which corresponds to one-fourth of the wavelength of the 2.4 GHz frequency band. Or, when a frequency of 5 GHz applicable for wireless network is tended to be applied to the antenna, the length of the radiating portion 113 is designated as approximately 1.5 cm which corresponds to one-fourth of the wavelength of the 5 GHz frequency band.

The coaxial cable 10 is directly applied in the antenna of the present invention as a conducting part of the antenna so as to reduce the shorten rate of the wavelength caused by the dielectric constant of the materials, so that the efficiency of the antenna is improved and becomes comparable to that of an external dipole antenna. Further, the usage rate of the materials for manufacturing the antenna is reduced so as to reduce the cost of the antenna. Additionally, the fixing member 15 is provided to fix the positions of the radiating portion 113 and the grounding portion 113 via the incompletely enclosing manner so as to keep the radiating direction and protect the radiating portion 113 and the grounding portion 131.

While the present invention has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. An antenna, comprising:
a coaxial cable, comprising:
a core wire, comprising a signal feeding portion, a connecting portion and a radiating portion, the connecting portion being electrically connected to the signal feeding portion and the radiating portion;
an inner insulating layer, enclosing the connecting portion;
a metal layer, partially enclosing the inner insulating layer, parts of the metal layer being separated from the inner insulating layer and comprise a grounding portion; and
an outer insulating layer, partially enclosing the metal layer and the grounding portion being exposed out.

2. The antenna according to claim 1, further comprising at least one fixing member provided for fixing the shapes and the positions of the radiating portion and the grounding portion.

3. The antenna according to claim 1, wherein an included angle is formed between the radiating portion and the grounding portion, the included angle is larger than zero degree.

4. The antenna according to claim 3, wherein the included angle is smaller than or equal to 180 degrees.

5. The antenna according to claim 2, wherein the at least one fixing member comprises a first fixing portion and a second fixing portion, the first fixing portion is provided for fixing the radiating portion, the second fixing portion is provided for fixing the grounding portion.

6. The antenna according to claim 5, wherein the radiating portion is fixed in the first fixing portion.

7. The antenna according to claim 5, wherein the grounding portion is fixed in the second fixing portion.

8. The antenna according to claim 1, wherein the grounding portion is linear.

9. The antenna according to claim 1, wherein the metal layer further comprises a covering portion enclosing the inner insulating layer and electrically connecting to the grounding portion.

10. The antenna according to claim 9, wherein one end of the grounding portion opposite to the covering portion is a free end.

11. The antenna according to claim 1, wherein the signal feeding portion and the radiating portion are located at two opposite ends of the connecting portion respectively.

12. The antenna according to claim 1, wherein one end of the radiating portion opposite to the connecting portion is a free end.
